(19) United States
(12) Patent Application Publication
(10) Pub. No.: US 2009/0165676 A1
(43) Pub. Date: Jul. 2, 2009

(54) BIS(N-SILYLALKYL)ASPARTIMIDES AND PROCESSES THEREFOR

(75) Inventors: STEVEN DALE ITTEL, WILMINGTON, DE (US); ALEXEI A. GRIDNEV, WILMINGTON, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilington, DE (US)

(21) Appl. No.: 12/342,284

(22) Filed: Dec. 23, 2008

Related U.S. Application Data
(60) Provisional application No. 61/016,654, filed on Dec. 26, 2007.

(51) Int. Cl. C07F 7/18; C09B 67/22; C09D 5/00

(52) U.S. Cl. 106/287.11; 548/406; 106/481

(57) ABSTRACT

Compositions of bis(N-silylalkyl)aspartimides and processes for their synthesis are provided. The compounds are useful, for example, for making primers, adhesives, surfactants, viscosity modifiers, processing aids, and other products. Compositions of bis(N-silylalkyl)aspartamide urethane isocyanates and processes for their synthesis are provided. The compositions are useful, for example, for making primers, adhesives, surfactants, viscosity modifiers, processing aids, and other products.

This application claims priority under 35 U.S.C. §119(e) from, and claims the benefit of U.S. Provisional Application No. 61/016,654, U.S. Provisional Application No. 61/016,657, U.S. Provisional Application No. 61/016,668, and U.S. Provisional Application No. 61/016,677, all filed on Dec. 26, 2007.

### FIELD OF THE INVENTION

The present invention relates to bis(N-silylalkyl)aspartimides and processes for their synthesis. The present invention also relates to the utility of these compounds and their formulations. The present invention further relates to compositions of bis(N-silylalkyl) aspartimide urethane isocyanates, processes for their synthesis and to the utility of these compounds and the compositions thereof.

### BACKGROUND

Reactive, highly-functionalized macromonomers are essential components of modern dispersants, inks, and paints. They are utilized in a variety of applications such as compatibilizers, stabilizers, dispersants, crosslinkers, curing agents, stain resists, resists and surfactants. There is always a need for new liquid macromonomers with high densities of reactive functionalization having new physical and chemical properties. Patent applications US 2007161675 and W02007094858 disclose new functionalized macromonomers and their utility in finishes.

Amine-functionalized compounds constitute a highly diverse class of organic molecules. Thus, a reaction with amines brings a wide range of new functionalities to their reaction products. Alkoxysilanes are useful for adhering organic coatings to inorganic surfaces such as metals or pigments.

U.S. Pat. No. 6,046,270 discloses silane-modified polyurethane resins, a process for their preparation and their use as moisture-curable resins.

U.S. Pat. No. 6,596,612 discloses a process for preparing a silane compound comprising the steps of a) providing an organo imide compound which is the reaction product of ammonia or a primary amine and an organic anhydride compound; and b) reacting the organo imide compound with an aminoorganosilane in an amine exchange reaction to produce an imidoorganosilane compound.

Trialkoxysilane-functionalized succinimides have been prepared by a Michael addition reaction of 3-aminopropyltriethoxysilane with substituted maleimides. (Tamami, Betrabet, Wilkes, Polymer Bulletin (Berlin, Germany), 30(4), 293-9,1993. Tomar, Anand, Varma, Journal of Polymer Materials 8(2), 139-43.1991; U.S. Pat. No. 3,966,531.)

### SUMMARY

In the present invention, bis(N-silylalkyl)aspartimides and processes for their synthesis are provided. The bis(N-silylalkyl)aspartimides and compositions containing them are useful, for example, for making primers, adhesives, surfactants, viscosity modifiers, processing aids, and other products. Also provided are compositions of bis(N-silylalkyl)aspartamide urethane isocyanates and processes for synthesis thereof. The compositions comprising bis(N-silylalkyl)aspartamide urethane isocyanates are useful, for example, for making primers, adhesives, surfactants, viscosity modifiers, processing aids, and other products.

One aspect of the present invention is bis(N-silylalkyl)aspartimides of Formula I having the structure:

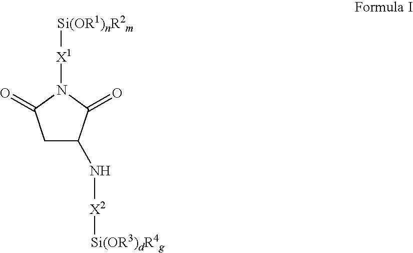

wherein R¹, R², R³, and R⁴ are each independently substituted or unsubstituted C₁ to C₁₀ linear alkyl, C₃ to C₁₀ branched or cyclic alkyl, C₆ to C₁₀ aryl or alkaryl, wherein the substituted linear, branched or cyclic alkyl, aryl or alkaryl can have one or more carbon atoms replaced with atoms selected from the group consisting of oxygen, nitrogen, silicon, and sulfur atoms, and one or more carbon atoms can bear fluorine or chlorine atom substituents, provided that the substituent does not react with the Si—O—R functionality; X¹ and X² are each independently substituted or unsubstituted C₂ to C₁₀ linear alkylene, C₃ to C₁₀ branched or cyclic alkylene, C₆ to C₁₀ arylene or alkarylene, wherein the substituted linear, branched or cyclic alkylene, arylene or alkarylene can have one or more carbon atoms replaced with atoms selected from the group consisting of oxygen, nitrogen, silicon, and sulfur atoms, and one or more carbon atoms can bear fluorine or chlorine atom substituents, provided that the substituent does not react with the Si—O—R functionality;
n and d are independently 1, 2 or 3;
m and g are independently 0, 1 or 2; and
n+m=d+g=3.

A further aspect of the present invention is processes for the synthesis of compounds of Formula I, wherein R¹, R², R³, R⁴, X¹, X² ,m, n, d, g, m+n and d+g, are the same as described above and said processes comprise contacting at least one compound of Formula II, wherein X═X¹ or X², with a compound of Formula IIa, wherein R⁴ is selected from the group consisting of hydrogen, methyl, ethyl, propyl and butyl.

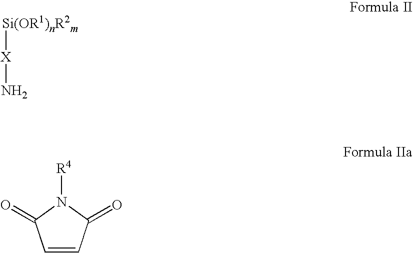

A further aspect of the present invention is bis(N-silylalkyl)aspartimide urethane isocyanates of Formula III:

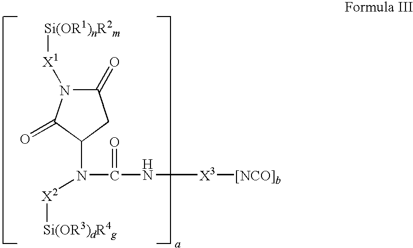

wherein R¹, R², R³, R⁴, X¹, X², n, and m are the same as described above; X³ is substituted or unsubstituted C₁ to C₄₀ linear alkylene, C₃ to C₄₀ branched or cyclic alkylene, C₆ to C₄₀ arylene or alkarylene, wherein the substituted linear, branched or cyclic alkylene, arylene or alkarylene can have one or more carbon atoms replaced with atoms selected from the group consisting of oxygen, nitrogen, silicon, and sulfur atoms, and one or more carbon atoms can bear fluorine or chlorine atom substituents, provided that the substituent does not react with the Si—O—R functionality; and a and b are both integers greater than or equal to 1.

A further aspect of the invention is processes for the preparation of compounds of Formula III, comprising contacting a compound of Formula I with a polyfunctional isocyanate, [O═C═N]ₐ—X³—[N═C═O]_{b}.

These and other aspects of the present invention will be apparent to those skilled in the art in view of the present disclosure and the appended claims.

### DETAILED DESCRIPTION

One embodiment of the present invention are bis(N-silylalkyl)aspartimides of Formula I:

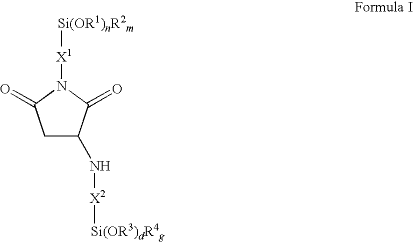

wherein R¹, R², R³, and R⁴ are each independently substituted or unsubstituted C₁ to C₁₀ linear alkyl, C₃ to C₁₀ branched or cyclic alkyl, C₆ to C₁₀ aryl or alkaryl, wherein the substituted linear, branched or cyclic alkyl, aryl or alkaryl can have one or more carbon atoms replaced with atoms selected from the group consisting of oxygen, nitrogen, silicon, and sulfur atoms, and one or more carbon atoms can bear fluorine or chlorine atom substituents, provided that the substituent does not react with the Si—O—R functionality; X¹ and X² are each independently substituted or unsubstituted C₂ to C₁₀ linear alkylene, C₃ to C₁₀ branched or cyclic alkylene, C₆ to C₁₀ arylene or alkarylene, wherein the substituted linear, branched or cyclic alkylene, arylene or alkarylene can have one or more carbon atoms replaced with atoms selected from the group consisting of oxygen, nitrogen, silicon, and sulfur atoms, and one or more carbon atoms can bear fluorine or chlorine atom substituents, provided that the substituent does not react with the Si—O—R functionality;
n and d are independently 1, 2, or 3;
m and g are independently 0, 1, or 2; and
n+m=d+g=3.

In some embodiments, X¹ and X² are the same. In some embodiments, X¹ and X² are 1,3-trimethylene. In some embodiments, n=d. In some embodiments, n and d are 3. In some embodiments, R¹ and R³ are methyl or ethyl.

The compounds of Formula I can be used alone or in conjunction with other compositions as inks, dispersants, adhesives, resists, automotive coatings, architectural coatings, paints, finishes, compatibilizers, adhesion promoters, biological agents, coupling agents, crosslinkers, curing agents, de-foamers, emulsifiers, flocculants, grafting agents, photopolymerizable materials, stabilizers, surface active agents, and viscosity modifiers. Examples of finishes include automotive coatings, architectural coatings, clear-coats, paints, high-solids finishes, aqueous-based finishes, and solvent-based finishes.

A further embodiment of the present invention is bis(N-silylalkyl)aspartimide urethane isocyanates of Formula III:

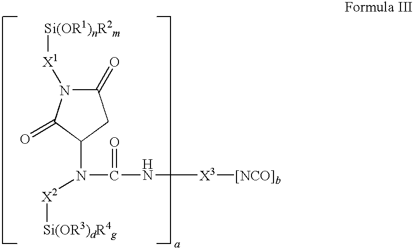

wherein R¹, R², R³, R⁴, X¹, X², n, m, d and g are the same as described above;
X³ is substituted or unsubstituted C₁ to C₄₀ linear alkylene, C₃ to C₄₀ branched or cyclic alkylene, C₆ to C₄₀ arylene or alkarylene, wherein the substituted linear, branched or cyclic alkylene, arylene or alkarylene can have one or more carbon atoms replaced with atoms selected from the group consisting of oxygen, nitrogen, silicon, and sulfur atoms, and one or more carbon atoms can bear fluorine or chlorine atom substituents, provided that the substituent does not react with the Si—O—R functionality; and
a and b are both integers greater than or equal to 1.

In commercially available organic isocyanate systems, (a+b) is typically 2 or 3, but in polymeric systems, (a+b) can be up to 1000.

Also provided in some embodiments are processes for the preparation of a compound of Formula III, said processes comprising contacting a compound represented by Formula I with a polyfunctional isocyanate, [O═C═N]ₐ—X³—[N═C═O]_{b}.

By “alkyl” is meant a monovalent linear, branched or cyclic saturated hydrocarbyl unit up to 10 carbon atoms, including methyl, ethyl, and propyl. Branched alkyl includes isopropyl, isobutyl, sec-butyl, and neopentyl. Cyclic alkyl includes monocyclic and polycyclic species such as cyclopentyl, cyclohexyl, methylcyclopentyl, norbornyl, and decahydronaphthyl.

A “substituted alkyl” is an alkyl having a non-hydrogen functionality attached to or in place of any of the carbon atoms of the alkyl, provided that at least one carbon atom remains in the substituted alkyl group. The substituents can be the same or different and include carboxylic ester, alkoxy, amino, trifluoromethyl, perfluoroalkyl, other substituted or unsubstituted alkyl, and substituted or unsubstituted aryl groups. Substituted alkyl also includes species in which one or more of the carbon atoms are substituted with heteroatoms such as oxygen, nitrogen, sulfur, silicon, or other elements, provided that at least one carbon atom remains in the substituted alkyl group. Substituted alkyl groups should not bear functionality that can react with alkoxysilanes or isocyanates.

In some embodiments, alkyl groups include methyl and ethyl. In some embodiments, substituted alkyl groups include methoxyethyl.

By “aryl” is meant monovalent aromatic and heteroaromatic groups, including phenyl, naphthyl, pyridyl, pyrimidyl, and benzoxoylanthracenyl groups.

By “arylene” is meant divalent aromatic groups, including aromatic and heteroaromatic rings such as phenylene, or naphthylene; phenylene is a preferred arylene for this invention.

By “alkarylene” is meant alkyl-substituted divalent aromatic groups, including aryl and heteroaryl rings such as alkyl-1,4-phenylene, or alkyl-substituted naphthylene. It also includes alkylenearylene groups such as methylenephenylene (—CH₂—C₆H₄—), or alkylenearylenealkylene groups such as (—CH₂—C₆H₄—CH₂—).

“Substituted aryl” refers to aromatic or heteroaromatic groups substituted with functional substituents such as carboxylic ester, alkoxy, amino, tertiary amino, trifluoromethyl, perfluoroalkyl, other substituted and unsubstituted alkyl, substituted and unsubstituted aryl, substituted and unsubstituted olefinic groups, and halogen.

By “alkylene” is meant a divalent linear, branched or cyclic saturated hydrocarbyl unit up to 40 carbon atoms, including methylene, ethylene, and propylene. Branched alkylene includes 1-methylethylene, 2-methylethylene, isobutylene, and sec-butylene. Cyclic alkylene includes monocyclic and polycyclic species such as cyclopentylene, 1,3- or 1,4-cyclohexylene, and dimethylenecyclohexane.

A “substituted alkylene” is an alkylene having a non-hydrogen functionality attached to or in place of any of the carbon atoms of the alkylene, provided that at least one carbon atom remains in the substituted alkylene group. The substituents can be the same or different and selected, for example, from alkoxy, amino, trifluoromethyl, perfluoroalkyl and other substituted and unsubstituted alkyl, and substituted and unsubstituted aryl. Substituted alkylene also includes species in which one or more of the carbon atoms other than the first carbon atom of the alkylene are substituted with heteroatoms such as oxygen, nitrogen, sulfur, silicon, tin or other elements. Substituted alkylene groups should not bear functionality that can react with alkoxysilanes.

In some embodiments, alkylene and substituted alkylene groups include ethylene, propylene, hexylene, and 3-azahexylene (aminoethylpropylene).

In some embodiments, there are provided compounds having the Formulas IV, V or VI.

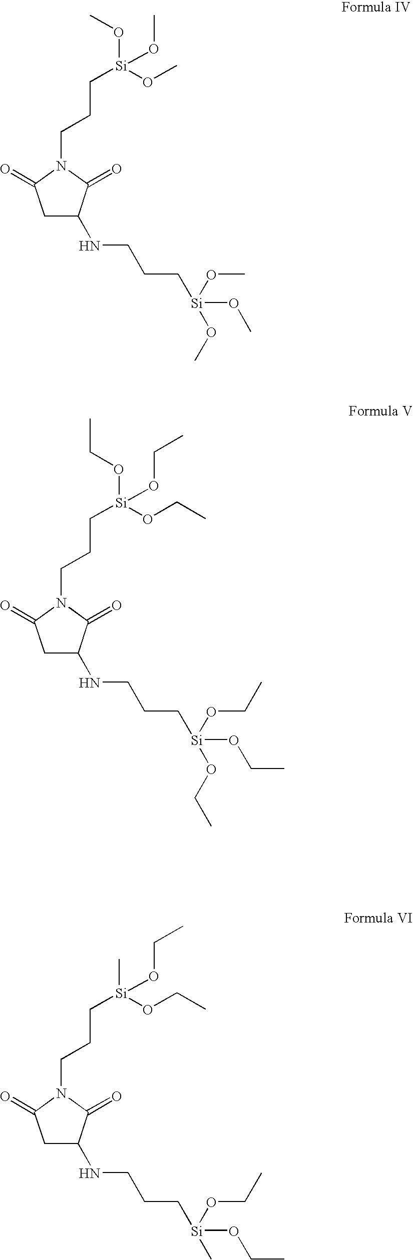

In some embodiments, compositions comprise combinations of two or more compounds having Formulas IV, V, and/or VI.

Compounds of Formulas I, IV, V, and VI can be prepared by any of several methods. The literature describes the synthesis of maleimides having the structure

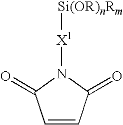

from maleic anhydride. The initial adduct of the reaction of aminoalkylsiloxane with maleic anhydride is the amic acid:

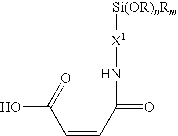

The amic acid can be ring-closed through dehydration by silylating the acid and amide groups with trimethylsilyl chloride in the presence of base, followed by elimination of bis(trimethylsilyl)ether (U.S. Pat. No. 6,191,286, 2001). An ene reaction of the maleimide will give the compounds of Formulas IV, V or VI.

An alternative synthesis using maleimides is based upon a modification of the method disclosed in U.S. Pat. No. 6,586,612. This patent discloses a process for preparing a silane compound comprising the steps of a) providing an organo imide compound which is the reaction product of ammonia or a primary amine and an organic anhydride compound; and b) reacting the organo imide compound with an aminoorganosilane in an amine exchange reaction to produce an imidoorganosilane compound. The process comprises contacting from 1.9 to 2.5 molar equivalents, preferably 2.0 molar equivalents, of

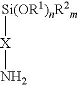

wherein X═X¹ and/or X², with one molar equivalent of

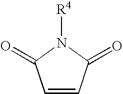

wherein R⁴ is hydrogen, methyl, ethyl, propyl or butyl. The desired product of Formula I is obtained.

Examples of suitable aminoalkyl alkoxysilanes include 2-aminoethyldimethylmethoxysilane; 6-aminohexyltributoxysilane; 3-aminopropyltrimethoxysilane; 3-aminopropyltriethoxysilane; 3-aminopropylmethyldiethoxysilane, 5-aminopentyltrimethoxysilane; 5-aminopentyltriethoxysilane, 3-aminopropyltriisopropoxysiloxane, and 4-amino-3,3-dimethylbutyidimethoxymethylsilane.

Suitable polyfunctional isocyanates for preparing the compounds of Formula III include monomeric diisocyanates and polyisocyanate adducts having an average functionality of 2 to 4, preferably 3.

Suitable monomeric diisocyanates are represented by the formula

X³(NCO)₂

wherein X³ represents the residue obtained by removing the isocyanate groups from a monomeric diisocyanate. When reacted stoichiometrically with the aminoalkyl succinimide, the isocyanate residue would be represented by

—X³(NCO)

wherein one of the original isocyanate functional groups of the difunctional isocyanate molecule reacted with the amine functionality and the other of the original isocyanate functional groups remains unreacted and available for further reactions such as crosslinking.

As a further example, suitable monomeric triisocyanates are represented by the formula

X³(NCO)₃

wherein X³ represents the residue obtained by removing the three isocyanate groups from a monomeric triisocyanate. When reacted with one aminoalkyl succinimide, the isocyanate residue would be represented by

—X³(NCO)₂

wherein one of the original isocyanate functional groups of the trifunctional isocyanate molecule reacted with the amine functionality and the other two of the original isocyanate functional groups remain unreacted and available for further reaction.

When reacted with two aminoalkyl succinimides, the isocyanate residue would be represented by

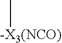

wherein two of the original isocyanate functional groups of the trifunctional isocyanate molecule reacted with the amine functionalities and the final of the original three isocyanate functional groups remains unreacted and available for further reaction.

The residual structure after all of the isocyanate groups have been removed constitutes X³, the core of an isocyanate molecule. This is further illustrated below.

Thus, using the trimer of hexamethylenediisocyanate

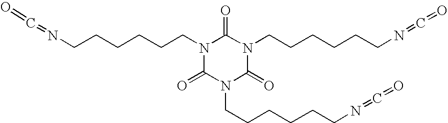

as an example, the core, X³, derived from that triisocyanate would be

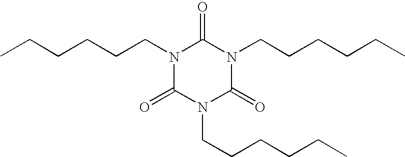

Using the diisocyanate, isophorone diisocyanate,

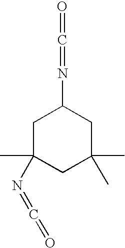

as an example, the isocyanate residue, X³, is

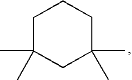

substituted in the appropriate positions indicated in the figure just above.

An illustrative example encompassed by Formula III is given by the structure:

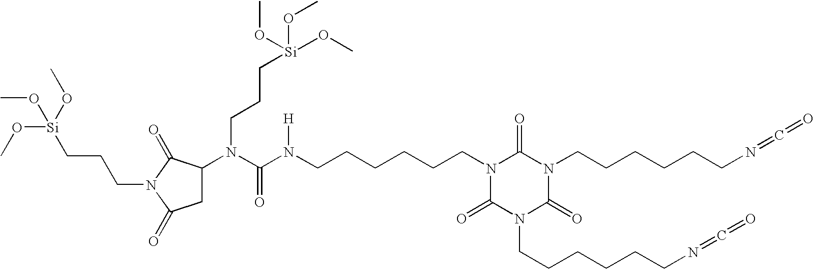

This specific example is the adduct of one equivalent of 1-[3-(trimethoxysilyl)propyl]-3-[3-(trimethoxysilyl)propylamino]-2,5-pyrrolidinedione), Formula IV, with one equivalent of the trifunctional trimer of hexamethylenediisocyanate. The amine N—H functionality of the 1-[3-(trimethoxysilyl)propyl]-3-[3-(trimethoxysilyl)propylamino]-2,5-pyrrolidinedione) reacts with one of the three isocyanates to form a urethane linkage, while two of the isocyanate groups remain for subsequent curing reactions. The trimethoxysilyl groups remain available for reaction with a hydroxylated inorganic substrate such as a metal surface.

Suitable monomeric polyfunctional isocyanates have a molecular weight of about 112 to 1,000, preferably about 140 to 400 and include those in which X³ represents a C₄ to C₄₀ alkylene group, preferably C₄ to C₁₈.

Examples of suitable polyfunctional diisocyanates include toluene-2,4-diisocyanate; toluene-2,6-diisocyanate; 1-isocyanato-3-isocyanatomethyl-3,5,5-trimethylcyclohexane (isophorone diisocyanate); 4,4′-diphenyl-methane diisocyanate; 3,3′-dimethyldiphenylmethane-4,4′-diisocyanate; m-phenylene diisocyanate; p-phenylene diisocyanate; bis-(4-isocyanatocyclohexyl)-methane, chlorophenylene diisocyanate; toluene-2,4,6-triisocyanate; 4,4′,4″-triphenylmethane triisocyanate; diphenyl ether 2,4,4′-triisocyanate; hexamethylene-1,6-diisocyanate; tetramethylene-1,4-diisocyanate, cyclohexane-1,4-diisocyanate; naphthalene-1,5-diisocyanate; 1-methoxyphenyl-2,4-diisocyanate; 4,4′-biphenylene diisocyanate; 3,3′-dimethoxy-4,4′-biphenyl diisocyanate; 3,3′-dimethyl-4,4′-biphenyl diisocyanate; 4,4′-dimethyldiphenylmethane-2,2′,5,5′-tetraisocyanate; 3,3′-dichlorophenyl-4,4′-diisocyanate; 2,2′,5,5′-tetrachlorodiphenyl-4,4,′-diisocyanate; trimethylhexamethylene diisocyanate; m-xylene diisocyanate; 1-isocyanato-1-methyl-4(3)-isocyanatomethyl cyclohexane, 2,4- and 2,6-toluylene diisocyanate, and 2,4-diphenyl-methane diisocyanate, polymethylene polyphenylisocyanates; and mixtures thereof.

Preferred diisocyanates include hexamethylene-1,6-diisocyanate, 1-isocyanato-3-isocyanatomethyl-3,5,5-trimethylcyclohexane (isophorone diisocyanate), bis-(4-isocyanatocyclohexyl)-methane, 1-isocyanato-1-methyl-4(3)-isocyanatomethyl cyclohexane, 2,4- and 2,6-toluylene diisocyanate, and 2,4- and 4,4′-diphenyl-methane diisocyanate.

Polyfunctional isocyanates containing 3 or more isocyanate groups such as N,N′,N″-tris(6-isocyanatohexyl)isocyanurate (the isocyanurate trimer of hexamethylene diisocyanate); DESMODUR® 3300 (CASRN:152287-11-1) available from Bayer; Tolonate® HDT (CASRN:118550-50-8) available from Rhodia; and the isocyanurate trimer of isophorone diamine, 4-isocyanantomethyl-1,8-octamethylenediisocyanate, and aromatic polyisocyanates such as 4,4′,4″-triphenylmethane triisocyanate and polyphenyl polymethylene polyfunctional isocyanates obtained by phosgenating aniline/formaldehyde condensates can also be used.

In accordance with the present invention, the polyfunctional isocyanate can also be present in the form of adducts of polyfunctional isocyanate. Suitable adducts of polyfunctional isocyanate are those containing isocyanurate, uretdione, biuret, urethane, allophanate, carbodiimide and/or oxadiazinetrione groups, such as those disclosed in U.S. Pat. No. 5,668,238.

The compounds of Formula I or III can be reacted with the hydroxylated surface of an inorganic substrate to yield compositions in which some or all of the Si(OR¹) and/or Si(OR³) groups are replaced with Si—O— linkages to the inorganic substrate. These compositions can be further functionalized, for example, by reaction with isocyanates.

Suitable inorganic substrates include metals, inorganic oxides, ceramics and glasses that contain surface hydroxyl groups.

Suitable metals include ferrous metals, iron, steel, stainless steel, aluminum, copper alloys, magnesium alloys and other metals used in the construction of automobiles, appliances, passenger cars, trucks, motorcycles, buses and toys. Suitable ceramics include refractory, inorganic, nonmetallic materials such as silica, silicon nitride, silicon carbide, alumina, zirconia or clays. Suitable glass substrates include fused mixtures of silicates of the alkali and alkaline earth metals. It is preferred that metal surfaces be pre-treated, for example with a phosphate salt or a chromate salt. Surface films formed by electrodeposition can be formed from an anionic or a cationic electrodeposition coating material. However, a cationic electrodeposition coating material is preferred since it provides excellent corrosion resistance.

The bis(N-silylalkyl)aspartimide urethane isocyanates of Formula III are useful in a wide variety of coating and adhesion applications. Other uses include cast, blown, spun or sprayed applications in fiber, film, sheet, composite materials, inks, paints, and multilayer coatings. The urethane isocyanates disclosed herein can be used in dispersants, adhesives, resists, automotive coatings, architectural coatings, paints, finishes, compatibilizers, adhesion promoters, biological agents, compatibilizers, coupling agents, crosslinkers, curing agents, de-foamers, emulsifiers, flocculants, grafting agents, photopolymerizable materials, stabilizers, surface active agents, and viscosity modifiers, adhesion promoters, coupling agents, clear-coats, high-solids finishes, aqueous-based finishes, and solvent-based finishes.

The aminoalkylsiloxane aspartamide adducts of Formula I are useful in a wide variety of coating and adhesion applications. Other uses include cast, blown, spun or sprayed applications in fiber, film, sheet, composite materials, inks, paints, and multilayer coatings. The aspartamides can be used in adhesives, adhesion promoters, biological agents, compatibilizers, coupling agents, crosslinkers, curing agents, dispersants, grafting agents, photopolymerizable materials, resists, stabilizers, surface active agents, surfactants, and viscosity modifiers. End products taking advantage of available characteristics can include, for example, automotive and architectural coatings or finishes, including high solids, aqueous, or solvent-based finishes.

Compounds of Formulas I and III are useful in primer compositions. Typical primer compositions provide improved adhesion of a coating to a substrate. The compositions disclosed herein provide adhesion to bare metal substrates, such as steel and aluminum, and to treated metal substrates such as galvanized steel. The primers provide a surface to which the topcoat, such as a pigmented mono coat or the basecoat of a base coat clear coat finish, will adhere.

Compounds of Formulas I and III are useful in coating compositions. Coating compositions can be used as a base coat or as a pigmented monocoat topcoat. Both of these compositions contain pigments. The pigments are formulated into mill bases by conventional procedures, such as grinding, sand milling, and high speed mixing. Generally, the mill base comprises pigment and a binder or a dispersant or both in a solvent-borne or aqueous medium. The mill base is added in an appropriate amount to the coating composition with mixing to form a pigmented coating composition. The composition claimed herein can be used as a dispersant, generally in conjunction with other organic materials.

Conventionally-used organic and inorganic pigments include white pigments, titanium dioxide, color pigments, metallic flakes such as aluminum flake, special effects pigments such as coated mica flakes, coated aluminum flakes and extender pigments including carbon black, barytes, silica, iron oxide and other pigments.

When used as a coating or primer, the coating compositions prepared according to the processes disclosed herein can be applied to substrates by conventional techniques, such as, spraying, electrostatic spraying, dipping, brushing, and flow coating.

Itaconimides can be used to prepare compounds of the following structure:

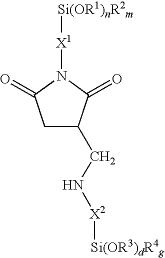

These itaconimide derivatives can be reacted with isocyanates to yield structures analogous to those of Formula III.

The itaconimide derivatives can also be reacted with the surface of an inorganic substrate to yield compositions in which some or all of the Si(OR¹) and/or Si(OR³) groups are replaced with Si—O— linkages to the inorganic substrate. These compositions can be further functionalized, for example, by reaction with isocyanates.

The itaconimide derivatives can be used in inks, dispersants, adhesives, resists, automotive coatings, architectural coatings, paints, finishes, compatibilizers, adhesion promoters, biological agents, compatibilizers, coupling agents, crosslinkers, curing agents, de-foamers, emulsifiers, flocculants, grafting agents, photopolymerizable materials, stabilizers, surface active agents, and viscosity modifiers.

### EXAMPLES

Gas chromatography was carried out on an HP-5890 gas chromatograph (Agilent Technologies, Santa Clara, Calif.) equipped with a flame ionization detector (FID) and autosampler and using a Phenomenex (Phenomenex Inc., Torrance, Calif.) ZB-5 column, 30 m×0.32 mm ID×0.25 micron with a one microliter injection. The GC method was programmed to start at 70° C. for 4 min, followed by temperature ramping to 300° C. at a rate of 10° C./min; the final temperature was held for 17 min. The masses of the various components were determined with an HP-6890 gas chromatograph equipped with an HP-5973 mass selective detector (MSD) and autosampler and using a J&W Scientific DB-5MS column (Agilent Technologies, Santa Clara, Calif.), 30 m×0.25 mm ID×0.25 micron column with a one microliter injection. The GC method was programmed to start at 70° C. for 4 min, followed by temperature ramping to 300° C. at rate of 10° C./min; the final temperature was held for 7 min. All infrared peaks are reported in cm⁻¹.

Starting materials for the syntheses were purchased from Fluka through Sigma Aldrich or directly from Sigma Aldrich, Inc. (St. Louis, Mo.) and from Gelest, Inc., Morrisville, Pa.). They were used as received.

### Example 1

### Synthesis of 1-[3-(trimethoxysilyl)propyl]-3-[3-(trimethoxysilyl)propylamino]-2,5-pyrrolidinedione

This Example demonstrates the addition of one and then two aminopropyltrimethoxysilanes to maleimide.

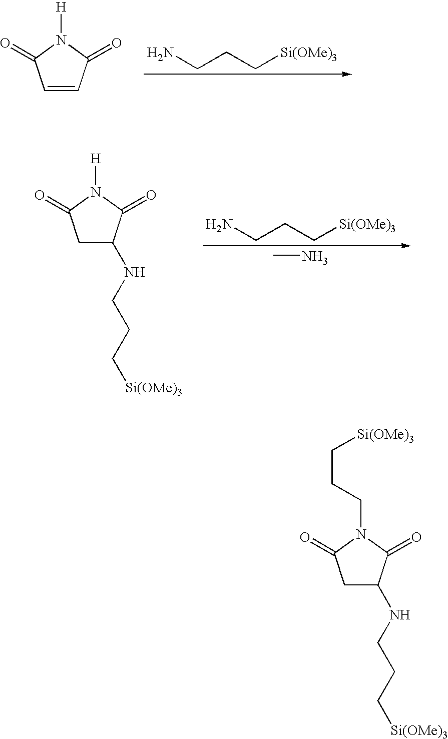

To a 250 mL, 3-neck round-bottom flask was added maleimide (20 g, 0.206 mol, 541-59-3, Aldrich), 3-aminopropyltrimethoxysilane (73.88 g, 0.412 mol, 13822-56-5, Fluka), and acetonitrile (100 mL). The reaction was allowed to stir at ambient under a continuous slow flush of nitrogen. A slight exotherm and darkening (clear, beige) of solution occurred upon the initial mixing. Progress of the reaction was followed by means of GC and GC/MS (GC method: ZB-5 column, 30 m×0.32 mm ID×0.25 um. Initial temperature was 70° C. Hold 4 min, then 10° C./min to 300° C. According to GC, within 15 min, maleimide (retention time 5.0 min) had disappeared and about half the aminosilane (retention time 7.6 min) remained. In addition, two products were observed corresponding to the monosilylated aminosuccinimide

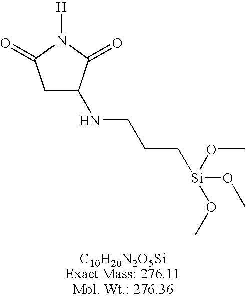

(retention time 20.0 min), and the disilylated aminosuccinimide

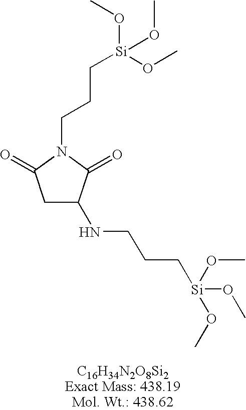

1-[3-(trimethoxysiyl)propyl]-3-[3-(trimethoxysilyl)propylamino]-2,5-pyrrolidinedione, (retention time 18.3 min) with the first of these being dominant. A sample taken after 12 days of stirring at about 20° C. revealed little residual starting material and a dominant peak of the disubstituted product. After 15 days of stirring at about 20° C., the slightly viscous solution was heated to 70° C. and then to 100° C. The solution turned pink in color. Carbon black was added to absorb the colored species along with 20 mL of additional acetonitrile and the slurry was filtered over Celite. The light beige filtrate was reduced under pressure to remove acetonitrile, yielding the product as a tan, somewhat viscous oil.

### Example 2

### Addition of Aminoalkylsilane to Maleimide

This Example demonstrates the addition of one and then two aminopropyltrimethoxysilanes to maleimide.

To a 250 mL 3-neck, round-bottomed flask under a flow of nitrogen was added maleimide (10.00 g, 0.103 mol) and acetonitrile (50 mL) resulting in a turbid white suspension. The temperature of the suspension dropped to ˜13° C. as the maleimide completely dissolved within minutes. The colorless solution was chilled in an acetone/ice bath to about −10° C. Liquid 3-aminopropyltrimethoxysilane (18.47 g, 0.103 mol) was then added via addition funnel at about 1 drop/second. The resulting mixture was allowed to stir at about 20° C. over the weekend resulting in a slightly cloudy, peach-colored solution. A second equivalent of the aminosilane (18.47 g, 0.103 mol) was added at about 20° C. and stirring with a nitrogen flush through flask was continued for about 3 weeks with monitoring by GC/MS. Solvent was then removed under reduced pressure yielding a peach-colored, slightly viscous liquid (27 g, 60%). ¹H NMR (CDCl₃): δ (ppm): 3.50 (s, 18H), 3.35 (m, 1H) 3.24 (m, 2H) 2.50 (br m, 3H) 2.38 (m, 1H) 1.50 (m, 4H) 1.22 (m, 4H). IR (KBr Plates): 3317s, 3206m, 3079w, 2943s, 2841 s, 2162vw, 1900vw, 1720m, 1668s, 1535m, 1467m, 1410m, 1312w, 1276w, 1192s,1086s, 819s, 678w.

### Example 3

### Addition of Aminopropyltriethoxysilane to Maleimide

This Example demonstrates the addition of two aminopropyltriethoxy-silane molecules to maleimide.

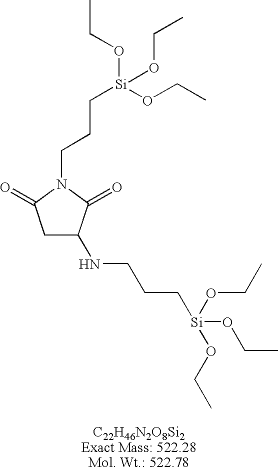

This reaction was carried out under nitrogen, with the initial steps being carried out in a nitrogen-flushed drybox. To a 250 mL, round-bottomed 3-neck flask was added maleimide (4.39 g, 0.0452 mol) and acetonitrile (50 mL) resulting in a turbid, white solution which was cooled in a −20° C. freezer for ˜30 min. Aminopropyltriethoxysilane (20.00 g, 0.0903 mol) was added drop-wise to the chilled solution (˜2 drops/second). The flask was removed from dry box and connected to nitrogen flow to flush out ammonia by-product and allowed to stir for ˜4 weeks. The reaction was sampled for GC/MS analysis during that time. Acetonitrile was removed under reduced pressure, and the flask was back-filled with nitrogen. Overnight, a white mass of circular spherulitic crystals formed in flask. A sample was taken for ¹H NMR analysis and seen to be the desired product in essentially pure form. Despite the NMR indicating a single product, GC/MS indicated a 3:1 mixture of two isomeric products having essentially identical mass spectra; the nature of this isomeric mixture is unknown. ¹H NMR (CDCl₃): δ (ppm): 3.76 (q, 12H), 3.30 (t,1H) 3.16 (m, 2H) 2.58 (m, 2H) 2.50 (m,1H) 2.42 (m,1H) 1.55 (m, 4H) 1.18 (t, 18H) 0.60 (m, 2H).

### Example 4

### Addition of Aminopropylmethyldiethoxysilane to Maleimide

This Example demonstrates the addition of one and then two aminopropylmethyldiethoxysilanes to maleimide.

The compound

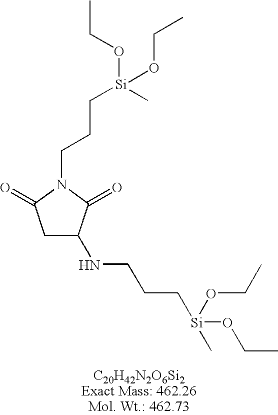

was prepared in a manner analogous to that in Example 2. ¹H NMR (CD₃CN): δ (ppm): 3.72 (q, 8H), 3.26 (dt, 1H), 3.12 (m, 2H), 2.55 (t, 1H), 2.50 (m, 2H), 2.30 (m, 1H), 1.48 (m, 4H), 1.14 (t, 12H), 0.55 (m, 4H) 0.04 (s, 6H). In addition, there was a broad singlet due to N—H observed at about 2.15, but the position of this peak was variable.

### Comparative Example A

### Attempted Addition of Silylated Aminosuccinimide to Dehydroxylated Alumina

As a first step, alumina (1.03 g Alumina-C from Degussa) suspended in ether (20 mL) was trimethylsilylated with trimethylsilylchloride (0.20 mL, Aldrich) to remove surface hydroxyls. An infrared spectrum (Fluorolube mull) may have indicated a lower concentration of surface hydroxyls relative to the starting silica, but the result was not clear. The alumina was better dispersed in the ether after the treatment.

As a second step, the surface-dehydroxylated alumina (0.47 g) suspended in ether (20 mL) was reacted with 1-[3-(trimethoxysilyl)propyl]-3-[3-(trimethoxysilyl)propylamino]-2,5-pyrrolidinedione, (0.10 mL). The sample was stirred to 30 minutes before collecting by vacuum filtration. The sample was then washed with two portions of ether (20 mL) before being dried under vacuum. An infrared spectrum (Fluorolube mull) was essentially the same as that from the first step. This indicates that 1-[3-(trimethoxysilyl)propyl]-3-[3-(trimethoxysilyl)propylamino]-2,5-pyrrolidinedione does not adhere to an alumina surface that has been treated with trimethylsilylchloride to remove surface OH groups.

### Comparative Example B

### Attempted Addition of Silylated Aminosuccinimide to Dehydroxylated Silica

As a first step, silica (1.04 g Aerosil 380 from Degussa) suspended in ether (20 mL) was trimethylsilylated with trimethylsilylchloride (0.20 mL, Aldrich) to remove surface hydroxyls. An infrared spectrum (Fluorolube mull) indicated a lower concentration of surface hydroxyls relative to the starting silica.

As a second step, the surface-dehydroxylated silica (0.0.52 g) suspended in ether (20 mL) was reacted with 1-[3-(trimethoxysilyl)propyl]-3-[3-(trimethoxysilyl)propylamino]-2,5-pyrrolidinedione (0.20 mL). The sample was stirred 30 minutes before collecting by vacuum filtration. The sample was then washed with two portions of ether (20 mL) before being dried under vacuum. An infrared spectrum (Fluorolube mull) was essentially the same as that from the first step. This is evidence indicating that 1-[3-(trimethoxysilyl)propyl]-3-[3-(trimethoxysilyl)propylamino]-2,5-pyrrolidinedione does not adhere to a silica surface that has been treated with trimethylsilylchloride to remove surface hydroxyl groups.

### Example 6

### Addition of Silylated Aminosuccinimide to an Alumina Surface

Alumina (1.07 g Alumina-C from Degussa) suspended in ether (20 mL) was reacted with 1-[3-(trimethoxysilyl)propyl]-3-[3-(trimethoxysilyl)propylamino]-2,5-pyrrolidinedione (0.20 mL). The sample was stirred 30 minutes before collecting by vacuum filtration. The sample was then washed with three portions of ether (20 mL) before being dried under vacuum. An infrared spectrum (Fluorolube mull) displayed a series of peaks that were in addition to the peaks that are attributed to the silica. They were (with corresponding peak from 1-[3-(trimethoxysilyl)propyl]-3-[3-(trimethoxysilyl)propylamino]-2,5-pyrrolidinedione): 3340(shoulder)(3317), 1658(1668), 1530(1535), and 1407(1410). This is evidence indicating that 1-[3-(trimethoxysilyl)propyl]-3-[3-(trimethoxysilyl)propylamino]-2,5-pyrrolidinedione is adhered to the alumina surface by reaction with the surface OH groups.

### Example 7

### Addition of Silylated Aminosuccinimides to a Silica Surface

Silica (0.97 g Aerosil 380 from Degussa) suspended in ether (20 mL) was reacted with 1-[3-(trimethoxysilyl)propyl]-3-[3-(trimethoxysilyl)propylamino]-2,5-pyrrolidinedione (0.20 mL). The sample was stirred 30 minutes before collecting by vacuum filtration. The sample was then washed with three portions of ether (20 mL) before being dried under vacuum. An infrared spectrum (Fluorolube mull) displayed a series of peaks that were in addition to the peaks that are attributed to the silica. They were (with corresponding peak from 1-[3-(trimethoxysilyl)propyl]-3-[3-(trimethoxysilyl)propylamino]-2,5-pyrrolidinedione): 3339(3317), 3200(shoulder)(3206), 2950(shoulder)(2942), 2848(2841), 1668(1668), 1536(1535), 1444(1440), and 1409(1410). This is a very high correlation between the two sets of peaks, indicating that 1-[3-(trimethoxysilyl)propyl]-3-[3-(trimethoxysilyl)propylamino]-2,5-pyrrolidinedione is adhered to the silica surface by reaction with the surface OH groups.

### Example 8

### Addition of an Isocyanate to a Silica Surface Primed with a Silylated Aminosuccinimide

Alumina (0.43 g from Example 6) was suspended in ether (20 mL) and treated with isophorone diisocyanate (0.30 mL, Aldrich). After stirring for 30 minutes, the sample was collected by vacuum filtration and washed with two portions of ether (20 mL) before being dried under vacuum. An infrared spectrum (Fluorolube mull) showed most of the peaks expected for the sample from Example 6. However, there was a strong new peak for isocyanate at 2263 that had not been removed by the washing, indicating that the isocyanate was attached to the surface.

### Example 9

### Addition of an Isocyanate to an Alumina Surface Primed with a Silylated Aminosuccinimide

Silica (0.33 g from Example 7) was suspended in ether (20 mL) and treated with isophorone diisocyanate (0.30 mL, Aldrich). After stirring for 30 minutes, the sample was collected by vacuum filtration and washed with two portions of ether (20 mL) before being dried under vacuum. An infrared spectrum (Fluorolube mull) showed most of the peaks expected for the sample from Example 7. However, there was a strong new peak for isocyanate at 2266 that had not been washed away, indicating that the isocyanate was now attached to the surface.

### Examples 10-13 and Comparative Examples C and D

### Addition of Isocyanate to a Silylated Aminosuccinimide

These examples demonstrate the addition of a polyisocyanate to an aminopropyltrimethoxysilyl succinimide to yield a silylated succinimide urethane isocyanate.

A solution of 0.44 g (1 mmol) of

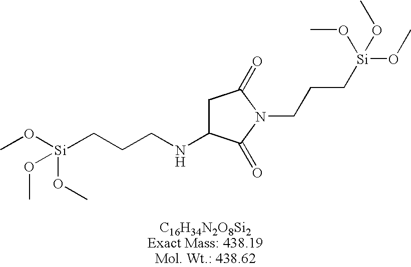

in CD₂Cl₂ was diluted to 5 mL to give a 0.2 molar solution.

A solution of 0.44 g (2 mmol) of isophoronediisocyanate (IPDI, Aldrich)

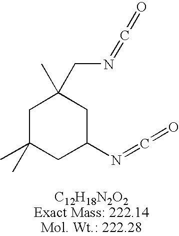

in CD₂Cl₂ was diluted to 5 mL to give a 0.4 molar solution. In a series of NMR tubes (Examples 10-13 and Comparative Examples C and D below) the indicated quantities of each solution were added giving the indicated molar ratio of the molecules.

| | mL | | mmol | mmol | mole ratio |
|---|---|---|---|---|---|
| | NH | mL IPDI | NH | IPDI | IPDI:NH |
| Comp. Example C | 1 | 0 | 0.2 | 0 | 0 |
| Example 10 | 1 | 0.125 | 0.2 | 0.05 | 0.25 |
| Example 11 | 1 | 0.25 | 0.2 | 0.1 | 0.5 |
| Example 12 | 1 | 0.5 | 0.2 | 0.2 | 1 |
| Example 13 | 1 | 1 | 0.2 | 0.4 | 2 |
| Comp. Example D | 0 | 1 | 0 | 0.4 | ∞ |

The samples were shaken and allowed to stand for 4 hours before obtaining the NMR spectra. After the spectra were run, several drops of the solutions from the NMR experiments were evaporated onto KBr IR plates in a drybox and the infrared spectra were obtained.

For Comparative Example C, the NMR spectrum was as described in Example 2. The single N—H NMR resonance was observed as a small roll in the baseline from 2.0 to 2.25 ppm. The resonances for the two different sets of SiOMe peaks (almost overlapping as a single line) were at 3.530 and 3.533 ppm.

In Example 10, one quarter equivalent of IPDI or half an equivalent of NCO functionality per equivalent of NH was added. Spectra indicate that as expected, both of the two different NCO groups are completely reacted. The single broad N—H NMR resonance has been replaced by a broad signal centered at 3.0 ppm. The resonances for the original two sets of Si(OMe) peaks are diminished from starting material and three additional peaks have grown in at 3.540, 3.545 and 3.550 ppm indicating that addition of NCO to the NH shifts the SiOMe resonances and that the two different ends of the diisocyanate yield two different resonances. The infrared spectrum is relatively unchanged from Comparative Example C, with no visible NCO stretch, indicating that the two different isocyanates on the IPDI are completely reacted.

In Example 11, one half equivalent of IPDI or one equivalent of NCO functionality per equivalent of NH was added. The resonances in this NMR spectrum are broader. The resonances for the original two sets of SiOMe peaks at 3.530 and 3.533 ppm are further diminished with a new one appearing at 3.526 ppm. The three peaks at 3.54 and 3.545 and 3.550 ppm are enhanced relative to the initial peaks indicating further addition of NCO to the remaining NH. Resonances in the range of 1.6-1.7 ppm indicate reacted IPDI. The infrared spectrum shows a small new peak at 2266 cm⁻¹ indicating just a trace of NCO remaining in the reaction. The reaction was either incomplete or of a stoichiometry that was just slightly off, the latter being more likely.

In Example 12, one equivalent of IPDI or two equivalents of NCO functionality per equivalent of NH had been added. The resonances for the original two sets of SiOMe peaks at 3.530, 3.533 and 3.526 ppm are about the same relative intensity. The peaks at 3.54 and 3.545 ppm were diminished relative to the initial peaks with peaks at 3.550 and 3.556 ppm being stronger. Resonances in the range of 1.6-1.7 ppm indicated reacted IPDI with a trace of unreacted IPDI visible in the range of 1.75-1.85 ppm. The infrared spectrum showed a strong peak at 2261 cm⁻¹ for free isocyanate. The spectra indicate that the most of the IPDI reacted through its more reactive NCO and the less reactive NCO remains largely unreacted. This is the most desired stoichiometry.

In Example 13, two equivalents of IPDI or four equivalents of NCO functionality per equivalent of NH were added. The resonances for the original two sets of SiOMe peaks at 3.530, 3.533 and 3.526 ppm were about the same intensity. The peaks at 3.54 and 3.545 ppm were further diminished relative to the spectrum of Example 12 and the peaks at 3.550 and 3.556 ppm were further enhanced. Resonances in the range of 1.6-1.7 ppm indicated reacted IPDI with a strong signal of unreacted IPDI in the range of 1.75-1.85 ppm as expected for this stoichiometry. The infrared spectrum showed a strong peak at 2261 cm⁻¹ for free isocyanate. The spectra indicated that the half of the IPDI reacted through its more reactive NCO and the less reactive NCO remained largely unreacted. These species can be differentiated by means of spectroscopy from free, unreacted IPDI in the system.

Comparative Example D was used as a standard for comparison of the NMR spectra in Examples 10-13.

### Examples 14 and 15

### Addition of Silylated Succinimide Urethane Isocyanate to Silica

These examples demonstrate the addition of a silylated succinimide urethane isocyanate to an inorganic surface.

Small portions (0.25 mL) of the solutions from Example 12 and Example 13 were mixed with samples of silica (0.5 g) suspended in ether (10 mL). The suspensions were stirred for 5 minutes. They were then collected by vacuum filtration. The collected materials were then each washed with three consecutive portions of ether (10 mL) before being dried under vacuum (Examples 14 and 15 respectively). Portions of the two resulting solids were mulled in Fluorolube on KBr plates and the infrared spectra were recorded. In Example 14, strong bands attributable to free isocyanate chemically bound to the surface through the repeated washings were visible at 2262 cm⁻¹. In Example 15, the isocyanate band was relatively equal in intensity to those in Example 14 indicating that the excess isocyanate present in Example 13 had been washed from the system. The spectra were very similar to those obtained in silica by the method recorded in Example 8.

What is claimed is:

1. A bis(N-silylalkyl)aspartimide having a structure according to Formula I 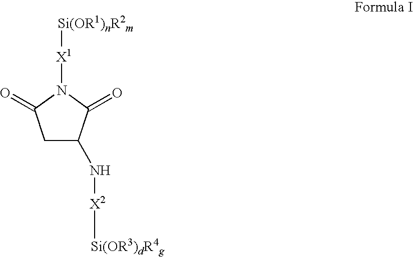
wherein R¹, R², R³, and R⁴ are each independently substituted or unsubstituted C₁ to C₁₀ linear alkyl, C₃ to C₁₀ branched or cyclic alkyl, C₆ to C₁₀ aryl or alkaryl, wherein the substituted linear, branched or cyclic alkyl, aryl or alkaryl can have one or more carbon atoms replaced with atoms selected from the group consisting of oxygen, nitrogen, silicon, and sulfur atoms, and wherein one or more carbon atoms can bear fluorine or chlorine atom substituents, provided that the substituent does not react with the Si—O—R functionality;
X¹ and X² are each independently substituted or unsubstituted C₂ to C₁₀ linear alkylene, C₃ to C₁₀ branched or cyclic alkylene, C₆ to C₁₀ arylene or alkarylene, wherein the substituted linear, branched or cyclic alkylene, arylene or alkarylene can have one or more carbon atoms replaced with atoms selected from the group consisting of oxygen, nitrogen, silicon, and sulfur atoms, and one or more carbon atoms can bear fluorine or chlorine atom substituents, provided that the substituent does not react with the Si—O—R functionality;
n and d are independently 1, 2, or 3;
m and g are independently 0, 1 or 2; and
n+m=d+g=3.

2. The bis(N-silylalkyl)aspartimide of claim 1 wherein X¹ and X² are 1,3-trimethylene.

3. The bis(N-silylalkyl)aspartimide of claim 1 wherein n=d.

4. The bis(N-silylalkyl)aspartimide of claim 1, wherein n and d are 3.

5. The bis(N-silylalkyl)aspartimide of claim 1 wherein R¹ and R³ are methyl or ethyl.

6. A composition comprising at least one bis(N-silylalkyl)aspartimide selected from the group of compounds of Formula IV, Formula V, and Formula VI:

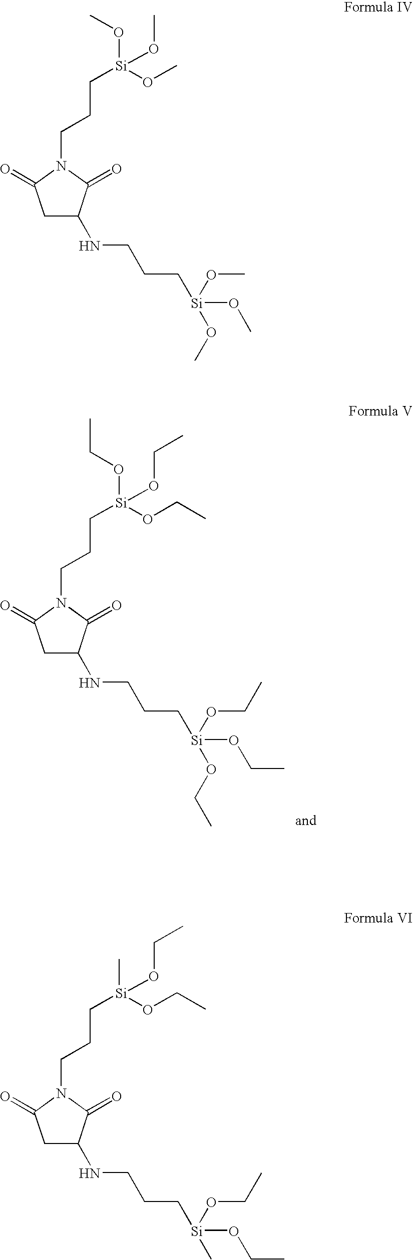

7. A composition comprising a bis(N-silylalkyl)aspartimide of claim 1, said composition selected from the group consisting of inks, dispersants, adhesives, resists, automotive coatings, architectural coatings, paints, finishes, compatibilizers, adhesion promoters, biological agents, coupling agents, crosslinkers, curing agents, de-foamers, emulsifiers, flocculants, grafting agents, photopolymerizable materials, stabilizers, surface active agents, and viscosity modifiers.

8. A coating composition comprising a pigment dispersion, wherein the pigment has been contacted with a bis(N-silylalkyl)aspartimide of claim 1.

9. An article produced by the reaction of an inorganic substrate comprising surface hydroxyl groups with a bis(N-silylalkyl)aspartimide of claim 1.

10. A bis(N-silylalkyl)aspartimide urethane isocyanate having a structure according to Formula III 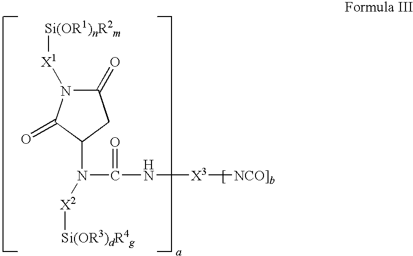
wherein R¹, R², R³, and R⁴ are each independently substituted or unsubstituted C₁ to C₁₀ linear alkyl, C₃ to C₁₀ branched or cyclic alkyl, C₆ to C₁₀ aryl or alkaryl, wherein the substituted linear, branched or cyclic alkyl, aryl or alkaryl can have one or more carbon atoms replaced with atoms selected from the group consisting of oxygen, nitrogen, silicon, and sulfur atoms, and wherein one or more carbon atoms can bear fluorine or chlorine atom substituents, provided that the substituent does not react with the Si—O—R functionality;
X¹ and X² are each independently substituted or unsubstituted, C₂ to C₁₀ linear alkylene, C₃ to C₁₀ branched or cyclic alkylene, C₆ to C₁₀ arylene or alkarylene, wherein the substituted linear, branched or cyclic alkylene, arylene or alkarylene can have one or more carbon atoms replaced with atoms selected from the group consisting of oxygen, nitrogen, silicon, and sulfur atoms, and wherein one or more carbon atoms can bear fluorine or chlorine atom substituents, provided that the substituent does not react with the Si—O—R functionality;
n and d are independently 1, 2 or 3;
m and g are independently 0, 1 or 2;
n+m=d+g=3;
X³ is substituted or unsubstituted C₁ to C₄₀ linear alkylene, C₃ to C₄₀ branched or cyclic alkylene, C₆ to C₄₀ arylene or alkarylene, wherein the substituted linear, branched or cyclic alkylene, arylene or alkarylene can have one or more carbon atoms replaced with atoms selected from the group consisting of oxygen, nitrogen, silicon, and sulfur atoms, and wherein one or more carbon atoms can bear fluorine or chlorine atom substituents, provided that the substituent does not react with the Si—O—R functionality; and
a and b are both integers greater than or equal to 1.

11. The bis(N-silylalkyl)aspartimide urethane isocyanate of claim 10 wherein a=1.

12. The bis(N-silylalkyl)aspartimide urethane isocyanate of claim 10, wherein X³ is derived from a polyfunctional isocyanate.

13. The bis(N-silylalkyl)aspartimide urethane isocyanate of claim 10, wherein X³ is derived from 1,6-hexamethylenediisocyanate, 1-isocyanato-3-isocyanatomethyl-3,5,5-trimethylcyclohexane (isophorone diisocyanate), bis-(4-isocyanatocyclohexyl)-methane, 1-isocyanato-1-methyl-4(3)-isocyanatomethyl cyclohexane, 2,4- and/or 2,6-toluylene diisocyanate, 2,4- and/or 4,4′-diphenyl-methane diisocyanate, N,N′,N″-tris(6-isocyanatohexyl)isocyanurate, the isocyanurate trimer of isophorone diamine, 4-isocyanantomethyl-1,8-octamethylenediisocyanate, 4,4′,4″-triphenylmethane triisocyanate, or polyphenyl polymethylene polyfunctional isocyanates obtained by phosgenating aniline/formaldehyde condensates.

14. A composition comprising a bis(N-silylalkyl)aspartimide urethane isocyanate of claim 10, said composition selected from the group consisting of inks, dispersants, adhesives, resists, automotive coatings, architectural coatings, paints, finishes, compatibilizers, adhesion promoters, biological agents, compatibilizers, coupling agents, crosslinkers, curing agents, de-foamers, emulsifiers, flocculent, grafting agents, photopolymerizable materials, stabilizers, surface active agents, and viscosity modifiers.

15. A coating composition comprising a pigment dispersion, wherein the pigment has been contacted with a bis(N-silylalkyl)aspartimide urethane isocyanate of claim 10.

16. A reaction product of of an inorganic substrate comprising surface hydroxyl groups with a bis(N-silylalkyl)aspartimide urethane isocyanate of claim 10.

17. The reaction product of claim 16 wherein the inorganic substrate comprises a metal, an inorganic oxide, a ceramic, a glass, a refractory inorganic nonmetallic material, silica, silicon nitride, silicon carbide, alumina, titania, zirconia, a clay, or a fused mixture of silicates of the alkali and alkaline earth metals.

18. The article of claim 16, wherein the metal is selected from the group consisting of ferrous metals, aluminum, copper alloys, and magnesium alloys.

19. A part for an automobile, truck, motorcycle or bus, said part having been contacted with a coating comprising a bis(N-silylalkyl)aspartimide urethane isocyanate of claim 10.

20. A process for the preparation of a bis(N-silylalkyl)aspartimide urethane isocyanate having a structure according to Formula III 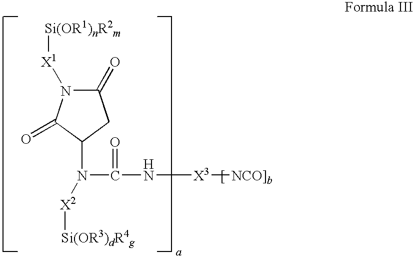
wherein R¹, R², R³, and R⁴ are each independently, substituted or unsubstituted C₁ to C₁₀ linear alkyl, C₃ to C₁₀ branched or cyclic alkyl, C₆ to C₁₀ aryl or alkaryl, wherein the substituted linear, branched or cyclic alkyl, aryl or alkaryl can have one or more carbon atoms replaced with atoms selected from the group consisting of oxygen, nitrogen, silicon, and sulfur atoms, and wherein one or more carbon atoms can bear fluorine or chlorine atom substituents, provided that the substituent does not react with the Si—O—R functionality;
X¹ and X² are each independently substituted or unsubstituted C₂ to C₁₀ linear alkylene, C₃ to C₁₀ branched or cyclic alkylene, C₆ to C₁₀ arylene or alkarylene, wherein the substituted linear, branched or cyclic alkylene, arylene or alkarylene can have one or more carbon atoms replaced with atoms selected from the group consisting of oxygen, nitrogen, silicon, and sulfur atoms, and wherein one or more carbon atoms can bear fluorine or chlorine atom substituents, provided that the substituent does not react with the Si—O—R functionality;
n and d are independently 1, 2, or 3;
m and g are independently 0, 1, or 2;
n+m=d+g=3;
X³ is substituted or unsubstituted C₁ to C₄₀ linear alkylene, C₃ to C₄₀ branched or cyclic alkylene, C₆ to C₄₀ arylene or alkarylene, wherein the substituted linear, branched or cyclic alkylene, arylene or alkarylene can have one or more carbon atoms replaced with atoms selected from the group consisting of oxygen, nitrogen, silicon, and sulfur atoms, and wherein one or more carbon atoms can bear fluorine or chlorine atom substituents, provided that the substituent does not react with the Si—O—R functionality; and
a and b are both integers greater than or equal to 1;
said process comprising contacting 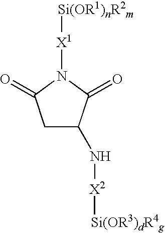
with a polyisocyanate, [O═C═N]ₐ—X³—[N═C⊚O]_{b}.

21. The process of claim 20, wherein R⁴ is hydrogen.
